(19) United States
(12) Patent Application Publication
(10) Pub. No.: US 2005/0083902 A1
(43) Pub. Date: Apr. 21, 2005

(54) Wireless communication system and method of reducing power consumption thereof

(75) Inventor: Tatsushi Hashimoto, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/931,989

(22) Filed: Sep. 2, 2004

(30) Foreign Application Priority Data
Oct. 9, 2003 (JP) 2003-350695

(51) Int. Cl. H04J 3/24

(52) U.S. Cl. 370/349

(57) ABSTRACT

In a wireless communication system capable of reducing power consumption in accordance with an actual transmission/reception status of each time slot even in an active mode, a wireless transmitter/receiver on a master side selects a high speed clock, supplies this clock to a CPU at the start of a reception time slot and reliably processes a reception packet. When a transmission packet to be transmitted in a next transmission time slot does not exist after completion of the processing of the reception packet, a clock signal is switched to a low speed clock. A wireless transmission/reception on a slave side surely supplies a high speed clock to the CPU at an intermediate part of the transmission time slot and prepares for the processing of the reception packet in the next reception time slot. When the effective reception packet is not detected in the reception time slot, the clock signal is switched to the low speed clock.

### BACKGROUND OF THE INVENTION

1. Field of the Invention

This invention relates to a technology for reducing power consumption in a wireless communication system by packet communication such as Bluetooth (trade mark of Bluetooth SIG Inc.).

2. Description of the Related Art

The following references can be cited as prior art references associated with the present application.

Patent Reference 1: Japanese Patent Kokai No. 9-26838

Patent Reference 2: Japanese Patent Kokai No. 9-128107

Patent Reference 3: Japanese Patent Kokai No. 9-231194

Patent Reference 4: Japanese Patent Kokai No. 2000-141626

Bluetooth, for example, has now become spread as a compact short-range wireless communication system in which a personal computer and its peripheral devices or familiar information terminals such as digital home appliances are wirelessly connected.

The Bluetooth is the short-range wireless communication system that was first proposed by Ericsson Inc., Sweden, and its development has been made since 1998 by Ericsson, Nokia Corp., Finland, Intel Corp., U.S.A., Internal Business Machines Corp., U.S.A and Toshiba Corp., Japan.

The Bluetooth is a standard directed to low power short-range wireless communication of a communication distance of about 10 m by use of a radio wave of 2.4 GHz band that is referred to as “ISM (Industrial Scientific Medical) Band” and can be used without license. In Bluetooth devices, transmission and reception of information can be made in a packet form between a device on a master side and a device on a slave side by using a wireless channel constituted by time slots alternately repeating transmission and reception in a predetermined cycle (625 μs).

Once the wireless channel is established between the master side device and the slave side device, the master side device needs to execute packet transmission/reception to/from the slave device in a predetermined cycle to keep the wireless channel. The Bluetooth stipulates specific operation modes (hold mode, sniff mode and park mode). in consideration of mobile terminals in order to reduce power consumption of the devices while executing packet transmission/reception for keeping the wireless channel.

In the hold mode, packet transmission/reception is temporarily interrupted while the wireless channel is held. A hold time is set immediately before the operation mode enters this hold mode and packet transmission/reception is stopped during this hold time. Therefore, the operation mode can shift to a sleep mode, etc, having low power consumption in this hold mode.

In the sniff mode, the packet is transmitted from the master side while the time slot is limited to a time slot called “sniff slot” having a predetermined cycle. During this sniff mode, therefore, the slave side device need not receive the packet other than the sniff slot and power consumption can thus be suppressed.

In the park mode, transmission of the packet is stopped while coming out of management of the master and while the slave side keeps synchronization of the time slots with the master side.

As explained above, the Bluetooth makes it possible to reduce power consumption by shifting the operation mode to any of the hold mode, the sniff mode and the park mode when the packet to be transmitted or received does not exist while the wireless channel remains established between the master side and the slave side.

The hold mode, the sniff mode and the part mode in the Bluetooth described above are directed to accomplish low power consumption by shifting the operation mode to these modes when no packet to be transmitted or received exists for at least a predetermined period.

However, in an active mode in which transmission/reception of the packet is ordinarily made, a low power consumption mode is not stipulated. In the case of packet communication, transmission/reception is not always made continuously even in the active mode and there are time slots in which transmission/reception of the packet is not made. Therefore, the hold mode, the sniff mode and the park mode alone cannot sufficiently accomplish low power consumption.

### SUMMARY OF THE INVENTION

An object of the present invention is to provide a wireless communication system capable of achieving low power consumption even in an active mode in accordance with an actual packet transmission/reception condition.

The invention provides a wireless communication system for executing packet communication between a transmitter/receiver on a master side and a transmitter/receiver on a slave side by using a wireless channel in which transmission time slots and reception time slots are alternately repeated in a predetermined time interval, wherein the transmitter/receiver on the master side always supplies a high speed clock to a central processing unit (hereinafter called “CPU”) for control at the start of a reception time slot, and when an effective reception packet is not detected in the reception time slot and a transmission packet to be transmitted in a next transmission time slot does not exist, or when the effective reception packet is received in the reception time slot but the transmission packet to be transmitted in the next transmission slot does not exist, the transmitter/receiver on the master side selects a low speed clock and supplies it to the CPU. The transmitter/receiver on the slave side selects the high speed clock and supplies it to the CPU for control processing when the transmission packet is not transmitted at an intermediate part of the transmission time slot, and selects the low speed clock and supplies it to the CPU when the effective reception packet is not detected in the reception time slot.

When it is known in advance that transmission/reception of the packet is not made in the next time slot, the invention switches the clock signal to the low speed clock even in the communication mode. Consequently, power consumption of the CPU due to the unnecessary high speed clock can be reduced.

### BRIEF DESCRIPTION OF THE DRAWINGS

FIG. 1 is a structural view of a wireless transmitter/receiver according to an embodiment of the invention;

FIG. 2 is a flowchart showing a clock control processing of a wireless transmitter/receiver on a maser side:

FIG. 3 is a time chart showing the operations of the wireless transmitter/receiver on the master side;

FIG. 4 is a flowchart showing a clock control processing of a wireless transmitter/receiver on the slave side; and

FIG. 5 is a time chart showing the operations of the wireless transmitter/receiver on the slave side.

### DESCRIPTION OF THE PREFERRED EMBODIMENTS

The above and other objects and novel features of the invention will become more apparent from the following description when taken in conjunction with reference to the accompanying drawings. However, the drawings are merely for the purpose of explanation but in no way limit the scope of the invention.

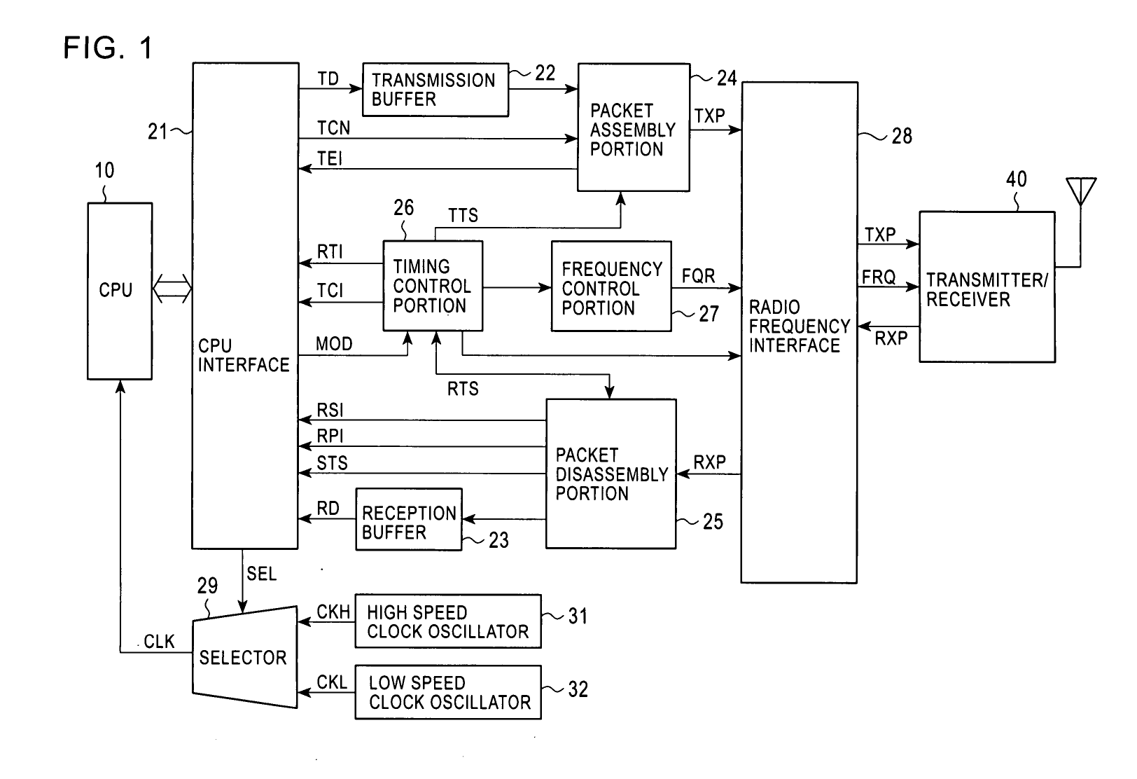

FIG. 1 is a structural view of a wireless transmitter/receiver according to an embodiment of the invention. This wireless transmitter/receiver is used as a device on the master side or on the slave side of a wireless communication system such as the Bluetooth described above and includes a CPU 10 for controlling the device as a whole. A transmission buffer 22 and a reception buffer 23 are connected to the CPU 10 through a CPU interface 21. The CPU interface 21 inputs and outputs data and control signals between the CPU 10 and each part. The transmission buffer 22 temporarily stores transmission data TD to be transmitted from the CPU 10 to a wireless transmitter/receiver of a counterpart and its output side is connected to a packet assembly portion 24. The reception buffer 23 temporarily stores the reception data RD received from the wireless transmitter/receiver of the counterpart so as to deliver the reception data RD to the CPU 10. The reception data RD is given from a packet disassembly portion 25.

The packet assembly portion 24 reads out the transmission data TD from the transmission buffer 22 in accordance with a transmission control signal TCN given from the CPU 10 and generates and outputs a transmission packet TXP in synchronism with a transmission slot timing signal TTS. In the case of the Bluetooth, the transmission packet TXP includes a 72-bit sync code, a 54-bit packet header continuing the former and a 0- to 2,720-bit variable length payload continuing the packet header, whenever necessary. The packet header contains a packet type, a transmission confirmation information bit, a packet sequence bit and an error check bit besides the transmission/reception address. The packet assembly portion 24 further outputs a transmission/reception completion interrupt signal TEI when the output of the transmission packet TXP is completed.

The packet disassembly portion 25 checks whether or not the reception packet RXP received through the wireless channel is addressed to the own station and whether or not it can be received without error, and stores the reception data RD correctly received into the reception buffer 23. Quite naturally, the reception packet RXP has the same construction as the transmission packet TXP. The packet disassembly portion 25 outputs the sync code reception interrupt signal RSI at the time of completion of reception of the sync code and the packet reception interrupt signal RPI at the time of completion of reception of the reception packet TXP together with a reception status signal STS representing the reception status of these signals, respectively. A reception slot timing signal RTS that is detected by the packet disassembly portion 25 and represents the start of the reception slot is used as the reference timing of transmission and reception on the slave side.

The wireless transmitter/receiver further includes a timing control portion 26 for controlling the timing of transmission and reception. The timing control portion 26 switches the master mode and the slave mode in accordance with a mode control signal MOD given from the CPU 10.

In the case of the master mode, the timing control portion 26 generates a transmission slot timing signal TTS and a reception slot timing signal RTS on the basis of a peculiar clock so as to alternately switch the transmission time slot and the reception time slot in a cycle of 625 μs and supplies these timing signals to the packet assembly portion 24 and the packet disassembly portion 25, respectively. The timing control portion 26 generates a reception slot start interrupt signal RTI at the start of the reception time slot and a transmission slot intermediate interrupt signal TCI at an intermediate part of the transmission time slot and supplies them to the CPU 10. The transmission slot intermediate interrupt signal TCI need not be generated at the center of the transmission time slot but may be generated at a timing at which the mode can shift to the operation mode of the CPU 10 so that reception can be reliably made at the next reception time slot.

In the case of the slave mode, the timing control portion 26 generates the transmission slot timing signal TTS on the basis of the reception slot timing signal RTS detected by the packet disassembly portion 25. The timing control portion 26 generates the reception slot start interrupt signal RTI at the start of the reception time slot and gives it to the CPU 10.

The timing control portion 26 further outputs a timing signal for frequency hopping to the frequency control portion 27 and a timing signal for operation control to the radio frequency interface 28 in both master and slave modes.

In the case of the Bluetooth, the frequency control portion 27 executes control for switching, at random and at a rate of 1,600 times/second, channels of 1 MHz obtained by dividing 2.4 to 2.4835 GHz by 79 by a pseudo-random series. The frequency control signal FRQ outputted from the frequency control portion 27 is given with the transmission packet TXP from the packet assembly portion 24 to the transmitter/receiver 40 through the radio frequency interface 28. The reception packet RXP received by the transmitter/receiver 40 is given to the packet disassembly portion 25 through the radio frequency interface 28.

The wireless transmitter/receiver further includes a high speed clock oscillator 31 for generating a high speed clock CKH (for example, 24 MHz) to be supplied to the CPU 10 in the communication mode in which the transmission/reception of the packet is made and a low speed clock generator 32 for generating a low speed clock CKL (for example, 32.768 KHz) to be supplied to the CPU 10 in the standby mode in which the transmission/reception is not made. Both high speed clock CKH and low speed clock CKL are supplied to a selector 29 and are selected in accordance with a select signal SEL given from the CPU 10 through the CPU interface 21. The selected signal is supplied as the clock signal CLK to the CPU 10.

Next, the operation of the wireless transmitter/receiver shown in FIG. 1 will be explained separately about the master side (1) and the slave side (2) and primarily about clock control for reducing power consumption.
(1) Operation of wireless transmitter/receiver on the master side:

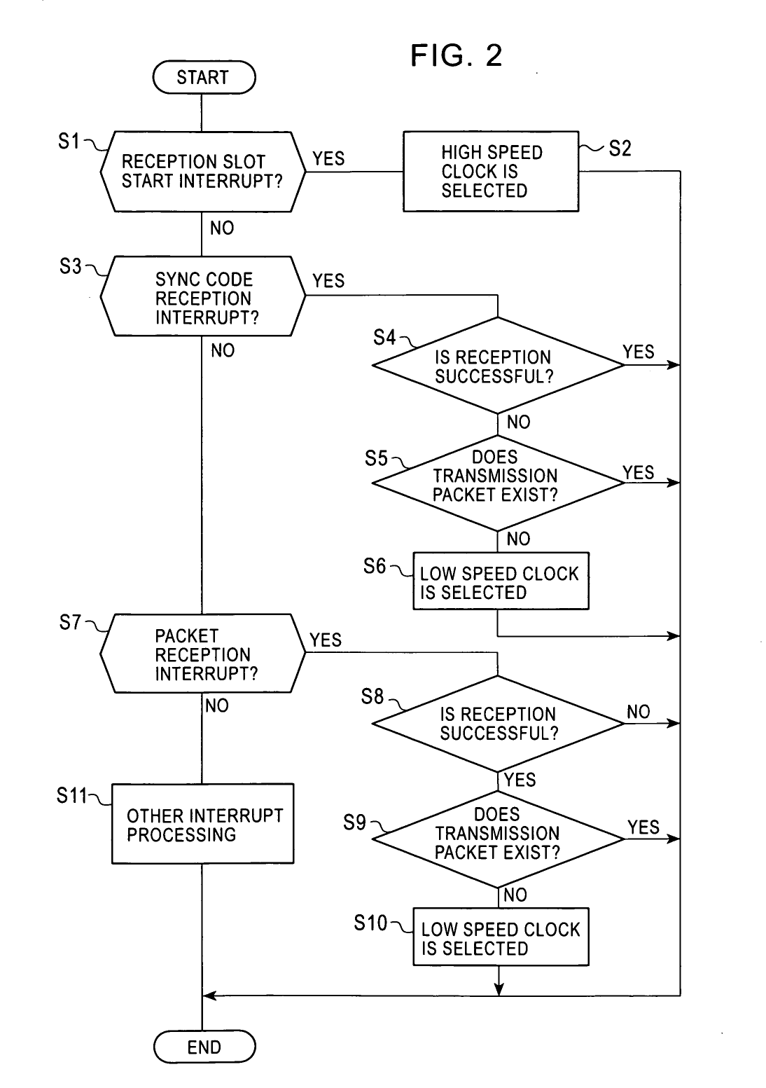

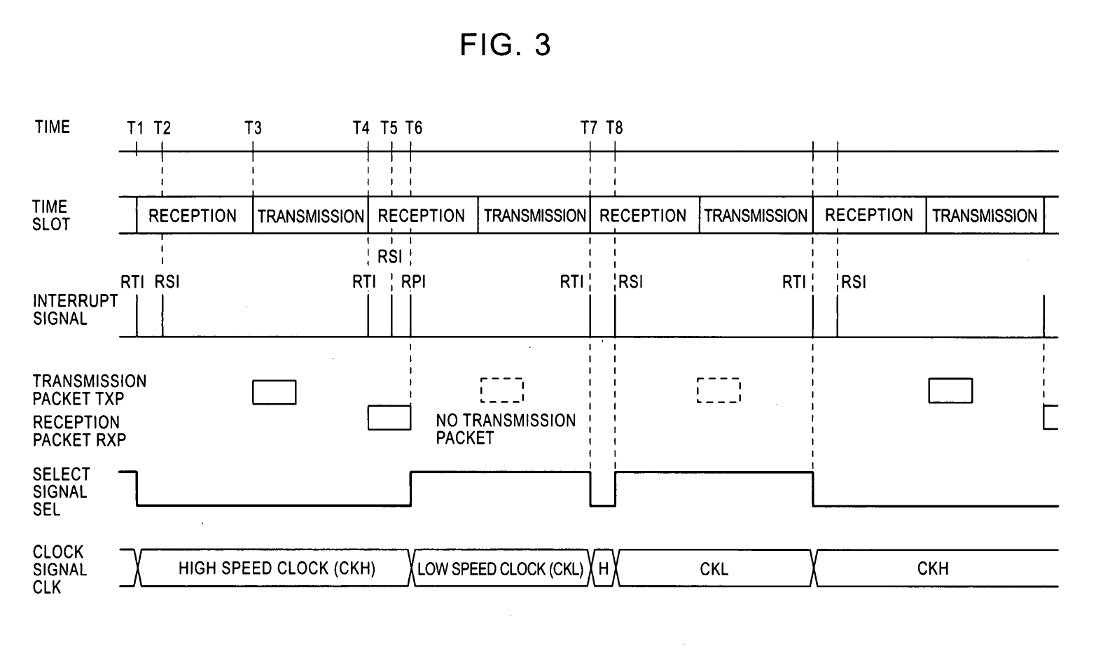

FIG. 2 is a flowchart showing a clock control processing of the wireless transmitter/receiver on the master side and FIG. 3 is a time chart showing the operation of the wireless transmitter/receiver on the master side. Incidentally, this clock control processing is executed by the CPU 10 set as the master in accordance with various kinds of interrupt signals.

The reception time slot is started at the time T1 in FIG. 3 and the timing control portion 26 shown in FIG. 1 outputs the reception slot start interrupt signal RT1. The CPU 10 starts the interrupt processing program in FIG. 2 and analyzes the interrupt cause. When the interrupt is judged as the reception slot start interrupt in step S1, the flow proceeds to step S2, the select signal SEL is set to a level “L”, the high speed clock CKH is selected and this interrupt processing is completed. In consequence, the selector 29 selects the high speed clock CKH outputted from the high speed clock oscillator 31 and supplies it as the clock signal CLK to the CPU 10.

When the time T2, that is, at the point at which the time corresponding to the sync code of the reception packet RXP from the time T1, lapses, the packet disassembly portion 26 outputs the sync code reception interrupt signal RSI and the reception status signal STS. When the CPU 10 judges in step S3 that the interrupt is the sync code reception interrupt, the flow proceeds to step S4 and the reception status signal STS is checked to judge whether or not reception proves successful. When the reception is successful, the reception operation needs to be continued and the interrupt processing is as such completed. When the reception is not successful, the effective reception data does not exist and the flow proceeds to step S5. Since the reception is not successful in the case of the time T2, the flow proceeds to step S5.

In step S5, whether or not the transmission packet to be transmitted in the next transmission time slot exists is judged. When the transmission packet exists, the communication mode must be kept and the interrupt processing is completed. When the transmission packet does not exist, the mode can shift to the standby mode. Therefore, after the flow proceeds to step S6 and the low speed clock CKL is selected, the interrupt processing is completed. Since the transmission packet to be next transmitted exists in the case of the time T2, the interrupt processing is as such completed after step S5.

The transmission time slot is started at the time T3 and the timing control portion 26 gives the transmission slot timing signal TTS to the packet assembly portion 24. The packet assembly portion 24 generates the transmission packet TXP. The transmission packet TXP is given to the transmitter/receiver 40 and the transmitter/receiver 40 transmits it by a wireless radio wave having a predetermined frequency in accordance with the frequency control signal FRQ given from the frequency control portion 27.

The next reception time slot is started at the time T4 and the timing control portion 26 outputs the reception slot start interrupt signal RTI. The high speed clock CKH is selected in the same way as in the case of the time T1.

At the time T5, that is, at the point at which the time corresponding to the sync code from the time T4, lapses, the sync code reception interrupt signal RSI and its reception status signal STS are outputted. When the interrupt is judged as the sync code reception interrupt in step S3 in the same way as in the case of the time T2, the flow proceeds to step S4, the reception status signal STS is checked and whether or not the reception proves successful is judged. Since the reception is successful in the case of the time T5 and the reception operation needs to be continued, the interrupt processing is as such completed.

When the packet reception is completed at the time T6, the packet disassembly portion 25 outputs the packet reception interrupt signal RPI and the reception status signal STS at that time. The interrupt is judged as the packet reception interrupt in step S7 and the flow proceeds to step S8. Whether or not the reception proves successful is then judged on the basis of the reception status signal STS. When the reception is not successful, the communication mode needs to be continued so as to report the reception error to the slave side and the interrupt processing is as such completed. When the reception is successful, the flow proceeds to step S9 and whether or not the transmission packet to be transmitted in the next transmission time slot exists is judged. When the transmission packet exists, the communication mode needs to be continued and the interrupt processing is as such completed. When the transmission packet does not exist, the mode can shift to the standby mode. Therefore, the flow proceeds to step S10 and after the low speed clock CKL is selected, the interrupt processing is completed. In the case of the time T6, the transmission packet to be next transmitted does not exist. Therefore, the flow proceeds to step S10 after step S9 and the low speed clock CKL is selected by setting the select signal SEL to a level H″. The CPU 10 then shifts to the standby mode.

The next reception time slot is started at the time T7 and the timing control portion 26 outputs the reception slot start interrupt signal RTI. The high speed clock CKH is selected in the same way as in the case of the time T1.

At the time T8, the sync code reception interrupt signal RSI and the reception status signal STS at that time are outputted. When the interrupt is judged in step S3 as the sync code reception interrupt in the same way as in the case of the time T2, the flow proceeds to step S4 and the reception status signal STS is checked to judge whether or not the reception proves successful. The reception is not successful in the case of the time T8 and the transmission packet to be transmitted at the next transmission time slot does not exist. Therefore, the flow proceeds to step S6, the low speed clock CKL is selected and the mode shifts to the standby mode.

The similar operation is thereafter repeated in each transmission/reception time slot in accordance with the existence and absence of the transmission packet and the reception packet.

As explained above, in the wireless transmitter/receiver on the master side, the high speed clock CKH is always supplied to the CPU 10 at the start of the reception time slot. Therefore, the reception packet RXP in this reception time slot can be reliably processed. When the effective reception packet is not detected and the transmission packet to be transmitted at the next transmission time slot does not exist or when the transmission packet to be transmitted at the next transmission time slot does not exist even though the effective reception packet RXP is received in the reception time slot, the low speed clock CLK is supplied to the CPU 10. Consequently, when it is known in advance that the transmission of the packet is not made in the next transmission time slot even in the communication mode, the clock signal CLK is switched to the low speed clock CKL and power consumption of the CPU 10 by the unnecessary high speed clock CKH can be reduced.
(2) Operation of wireless transmitter/receiver on the slave side:

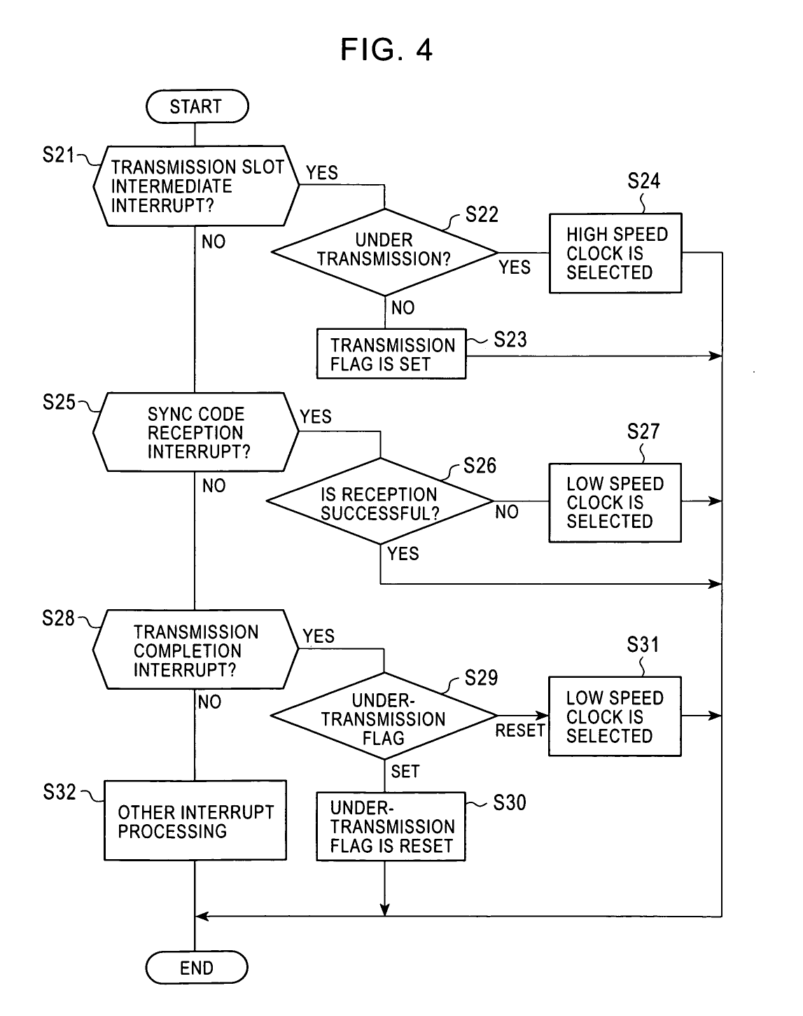

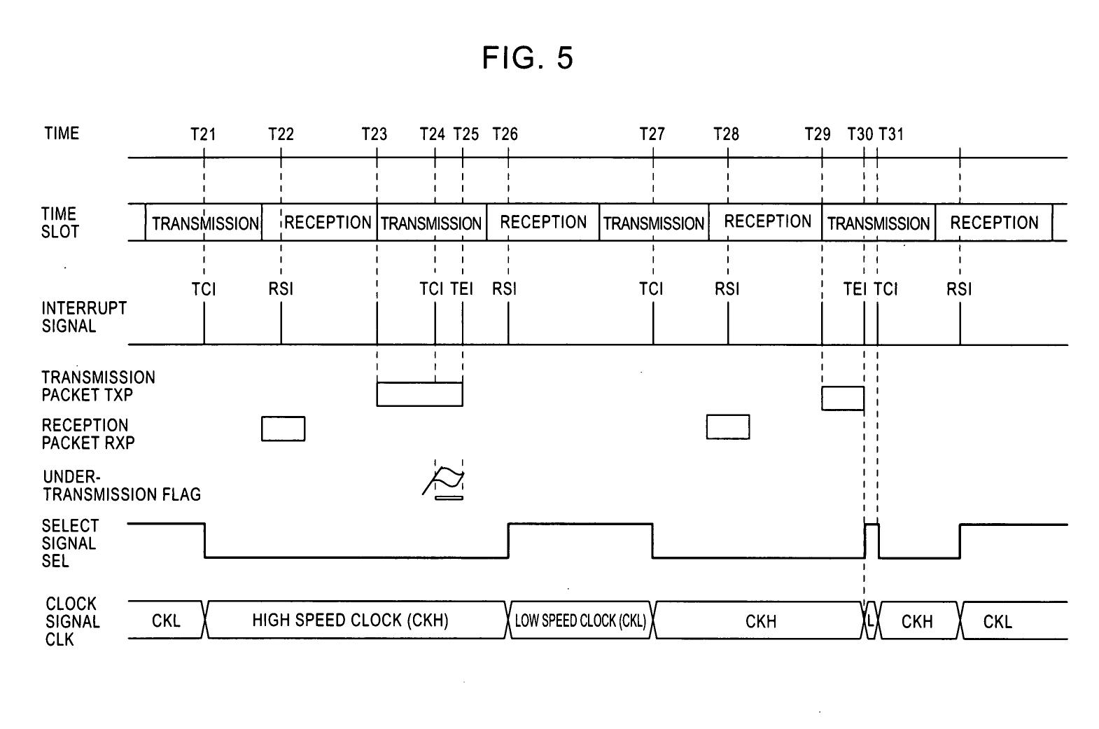

FIG. 4 is a flowchart showing the clock control processing of the wireless transmitter/receiver on the slave side and FIG. 5 is a time chart showing the operation of the wireless transmitter/receiver on the slave side. Incidentally, this clock control processing is executed by the CPU 10 set as the slave in accordance with various kinds of interrupt signals.

The timing control portion 26 shown in FIG. 1 outputs the transmission slot intermediate interrupt signal TCI at the intermediate part of the transmission time slot at the time T21 shown in FIG. 5. The CPU 10 starts the interrupt processing program shown in FIG. 4 and analyzes the interrupt cause. When the interrupt is judged as the transmission slot intermediate interrupt in step S21, the flow proceeds to step S22 and whether or not the present transmission packet is under transmission is checked. When it is under transmission, the flow proceeds to step S23, an under-transmission flag is set and the processing for this interrupt is completed. When the present transmission packet is not under transmission, the flow proceeds to step S24. To prepare for the reception of the packet from the master side in the next reception time slot, the select signal SEL is set to “L” and the high speed clock CKH is selected. The processing for this interrupt is then completed. In the case of the time T21, the packet is not under transmission. Therefore, the under-transmission flag is not set, the select signal SEL is set to “L” and the high speed clock CKH is selected.

The packet disassembly portion 26 outputs the sync code reception interrupt signal RSI and the reception status signal STS at that time at the time T22. When the interrupt is judged as the sync code reception interrupt in step S25, the flow proceeds to step S26 and the reception status signal STS is checked to judge whether or not the reception proves successful. When the reception proves successful, the reception operation needs to be further continued and the interrupt processing is as such completed. When the reception is not successful, the flow proceeds to step S27 because the effective reception data does not exist, and the interrupt processing is completed by selecting the low speed clock CKL. Since the reception is successful in the case of the time T22, the reception processing is as such continued.

Since the transmission time slot starts at the time T23, the transmission of the transmission packet TXP is executed and the transmission slot intermediate interrupt signal TCI is outputted at the time T24. Since the transmission packet TXP is under transmission in the case of the time T24, the transmission flag is set.

When the transmission of the transmission packet TXP is completed at the time T25, the packet assembly portion 24 outputs a transmission completion interrupt signal TEI. When the interrupt is judged as the transmission completion interrupt in step S28, the flow proceeds to step S29 and the status of the under-transmission flag is checked. When the under-transmission flag is set, the flow proceeds to step S30 and the interrupt processing is completed by resetting the under-transmission flag. When the under-transmission flag is not set, the select signal SEL is set to “H” and the low speed clock CKL is selected. Since the under-transmission flag is set in the case of the time T25, this under-transmission flag is reset.

The sync code reception interrupt signal RSI and the reception status signal STS at that time are outputted at the time T26 in the same way as in the case of the time T22. Since reception is not successful and the effective reception data does not exist in the case of the time T26, the flow proceeds to step S27 and the interrupt processing is completed by selecting the low speed clock CKL. Consequently, the CPU 10 shifts to the standby mode.

The transmission slot intermediate interrupt signal TCI is outputted at the time T27 in the same way as in the case of the time T21. Since no transmission is made at the time T27, the select signal SEL is set to “L” and the high speed clock CKH is selected.

The sync code reception interrupt signal RSI and the reception status signal STS at that time are outputted at the time T28. Since the reception is successful in the case of the time T28, the reception processing is as such continued.

Transmission of the transmission packet TXP is started at the time T29. The transmission of the transmission packet TXP is completed at the time T30 and the transmission completion interrupt signal TEI is outputted. Since the under-transmission flag is not set at this time, the flow proceeds from step S29 to step S31, the low speed clock CKL is selected and the CPU 10 shifts to the standby mode. When the transmission slot intermediate interrupt signal TCI is outputted at the time T31, the high speed clock CKH is selected this time in step S24 and the CPU 10 proceeds to the communication mode.

The similar operation is thereafter repeated in each transmission/reception time slot in accordance with the existence and absence of the reception packet.

As explained above, the wireless transmitter/receiver on the slave side supplies the high speed clock CKH to the CPU 10 when the transmission packet is not transmitted at the intermediate part of the transmission time slot and can therefore process reliably the reception packet RXP in the next reception time slot. When the effective reception packet is not detected in the reception time slot, the low speed clock CKL is supplied to the CPU 10. Consequently, when the reception packet from the master side does not exist even in the communication mode, the clock signal CLK is switched to the low speed clock CKL and power consumption of the CPU 10 due to the unnecessary high speed clock CKH can be reduced.

Incidentally, the embodiment explained above is merely directed to clarify the technical content of the invention. Therefore, the invention should not be interpreted limitedly while being limited only to the embodiment given above, but can be modified and executed in various ways within the scope of claim of the invention. Modified embodiments of the invention include the following by way of example.
(a) Though the select signal SEL for switching the clock signal CLK is controlled by the software of the CPU 10, switching may be made by means of hardware.
(b) Control for switching the clock signal CLK is not limited to the examples shown in FIGS. 2 and 4. In FIG. 4, for example, the under-transmission flag is set when transmission is underway at the time of the transmission slot intermediate interrupt in step S21 but may also be set at the transmission start of the transmission packet.
(c) The embodiment concretely explains the application of the invention to the Bluetooth but the invention can similarly be applied to wireless communication systems by other packet communication systems.

This application is based on Japanese Patent Application No. 2003-350695 which is herein incorporated by reference.

1. A wireless communication system for executing packet communication between a transmitter/receiver on a master side and a transmitter/receiver on a slave side by using a wireless channel in which transmission time slots and reception time slots are alternately repeated in a predetermined time interval, wherein:
said transmitter/receiver on the master side includes;
a central processing unit for controlling said transmitter/receiver as a whole;
a high speed clock oscillator for generating a high speed clock to be supplied to said central processing unit in an operation mode in which said transmitter/receiver is under communication; and
a low speed clock oscillator for generating a low speed clock to be supplied to said central processing unit in a standby mode in which said transmission/receiver does not execute communication; and wherein:
said high speed clock is always selected at the start of the reception time slot of said wireless channel and is supplied to said central processing unit, and when an effective reception packet is not detected in said reception time slot and a transmission packet to be transmitted in a next transmission time slot does not exist, or when the effective reception packet is received in the reception time slot but the transmission packet to be transmitted in the next transmission slot does not exist, said low speed clock is selected and is supplied to said central processing unit.

2. A wireless communication system for executing packet communication between a transmitter/receiver on a master side and a transmitter/receiver on a slave side by using a wireless channel in which transmission time slots and reception time slots are alternately repeated in a predetermined time interval, wherein:
said transmitter/receiver on the slave side includes;
a central processing unit for controlling said transmitter/receiver as a whole;
a high speed clock oscillator for generating a high speed clock to be supplied to said central processing unit in an operation mode in which said transmitter/receiver is under communication; and
a low speed clock oscillator for generating a low speed clock to be supplied to said central processing unit in a standby mode in which said transmission/receiver does not execute communication; and wherein:
when the transmission packet is not transmitted at an intermediate part of the transmission time slot of said wireless channel, said high speed clock is selected and is supplied to said central processing unit and when an effective reception packet is not detected in said reception time slot, said low speed clock is selected and is supplied to said central processing unit.

3. A method for reducing power consumption in a wireless communication system for executing packet communication between a transmitter/receiver on a master side and a transmitter/receiver on a slave side by using a wireless channel in which transmission time slots and reception time slots are alternately repeated in a predetermined time interval, wherein:
said transmitter/receiver on the master side always supplies a high speed clock to a central processing unit for control at the start of the reception time slot of said wireless channel, and when an effective reception packet is not detected in said reception time slot and a transmission packet to be transmitted in a next transmission time slot does not exist, or when the effective reception packet is received in the reception time slot but the transmission packet to be transmitted in the next transmission slot does not exist, said low speed clock is selected and is supplied to said central processing unit.

4. A method for reducing power consumption in a wireless communication system for executing packet communication between a transmitter/receiver on a master side and a transmitter/receiver on a slave side by using a wireless channel in which transmission time slots and reception time slots are alternately repeated in a predetermined time interval, wherein:
said transmitter/receiver on the slave side selects said high speed clock and supplies it to a central processing unit for control when the transmission packet is not transmitted at an intermediate part of the transmission time slot of said wireless channel, and selects said low speed clock and supplies it to said central processing unit when an effective reception packet is not detected in said reception time slot.
